(19) United States
(12) Patent Application Publication
(10) Pub. No.: US 2019/0112847 A1
(43) Pub. Date: Apr. 18, 2019

(54) DOOR LOCK DEVICE FOR VEHICLE

(71) Applicant: TOYOTA JIDOSHA KABUSHIKI KAISHA, Toyota-shi (JP)

(72) Inventors: Satoshi TAKATO, Nagoya-shi (JP); Tatsuya SHIMIZU, Okazaki-shi (JP); Naoki KAJIGAI, Anjo-shi (JP)

(73) Assignee: TOYOTA JIDOSHA KABUSHIKI KAISHA, Toyota-shi (JP)

(21) Appl. No.: 16/152,552

(22) Filed: Oct. 5, 2018

(30) Foreign Application Priority Data
Oct. 12, 2017 (JP) 2017-198292

(51) Int. Cl. E05B 85/26; E05B 85/24

(52) U.S. Cl. CPC E05B 85/26; E05Y 2900/531; E05B 85/243

(57) ABSTRACT

In a door closed state, a first locking section of a first pole abuts a latch, and the latch is kept in a full-latch position. In addition, a second locking section of a second pole abuts the first pole, and the first pole is kept in an abutting state against the latch. When a door handle is operated, the second pole pivots, the first pole and the latch are unlocked, and a door opening operation is thereby permitted. An arm of moment that is generated around a first pole axis by a force exerted on the first locking section from the latch is shorter than an arm of moment around the first pole axis that generates a force exerted on the second locking section from the first pole.

### CROSS REFERENCE TO RELATED APPLICATION

The disclosure of Japanese Patent Application No. 2017-198292 filed on Oct. 12, 2017 including the specification, claims, drawings, and abstract is incorporated herein by reference in its entirety.

### TECHNICAL FIELD

The present disclosure relates to a door lock device that keeps a vehicle door in a closed state.

### BACKGROUND

A vehicle such as an automobile is frequently provided with a mechanism that latches a door to prevent unintentional opening of the door. The following function is also known; even when the door is not completely latched (fully latched), the door is brought into a half-latch state to prevent opening of the door.

One example of a door lock device for a vehicle is disclosed in PATENT DOCUMENT 1 below. When a latch (2) provided on a door side is engaged with a striker (4) provided on a vehicle body side, a door is kept in a closed state. In the door closed state, a pawl (5a) of a pole (5) is engaged with a full-latch engagement section (2d) of the latch (2), and the latch (2) is thereby inhibited from pivoting and held in a latching position (see paragraph 0006). When the door is opened, a door handle is operated to make the pole (5) retreat from the latch (2), and a pivot of the latch (2) is thereby permitted. Note that the above reference signs in the parentheses are reference signs used in PATENT DOCUMENT 1 below and are not related to reference signs used in an embodiment of the present application.

### CITATION LIST

PATENT DOCUMENT 1: JP 7-42433 A

### SUMMARY

### Technical Problem

In the door opening operation, the pole attempts to retreat from the latch as an occupant operates the door handle. Meanwhile, since the door moves in an opened direction, the latch attempts to pivot when receiving a force from the striker. When pivoting, the latch pushes the pole. Consequently, a magnitude of friction between the latch and the pole is increased, which hinders movement of the pole. Thus, the door handle feels heavy when being operated.

The present disclosure has a purpose of allowing an operation of a door operation piece such as a door handle with a small force during a door opening operation.

### Solution to Problem

A door lock device for a vehicle in the present disclosure is provided in a door of a vehicle and is engaged with a striker that is fixed to a vehicle body to lock the door. The door lock device includes: a latch having a receiving groove that receives the striker fixed to the vehicle body; a first pole having a first locking section that abuts the latch and keeps this latch in a full-latch position in a door closed state; and a second pole having a second locking section that abuts the first pole and keeps this first pole in an abutting state against the latch in the door closed state. The latch, the first pole, and the second pole are pivotable about a first axis, a second axis, and a third axis, respectively. In particular, the second pole pivots about the third axis when a door operation piece such as a door handle is operated.

When an attempt is made to open the door in the door closed state, the striker causes the pivot of the latch, and a force (F1) is exerted on the first locking section of the first pole from the latch. Moment is generated around the second axis by this force (F1). Furthermore, this moment generates a force (F2) that is exerted on the second locking section of the second pole from the first pole. In this door lock device, a shape and arrangement of each of the latch, the first pole, and the second pole are determined such that an arm (r1) of the moment that is generated around the second axis by the force (F1) exerted on the first locking section of the first pole from the latch becomes shorter than an arm (r2) of the moment around the second axis that generates the force (F2) exerted on the second locking section of the second pole from the first pole.

Due to a length relationship of the above moment arms (r1<r2), the force exerted on the second locking section of the second pole from the first pole becomes smaller than the force exerted on the first locking section of the first pole from the latch (F1>F2). Accordingly, a frictional force (R2) that acts on a contact surface between the first pole and the second locking section of the second pole becomes smaller than a frictional force (R1) that acts on a contact surface between the latch and the first locking section of the first pole. Thus, an operation force of the door operation piece that resists the frictional force (R2) acting on the contact surface between the first pole and the second locking section of the second pole is reduced.

Furthermore, the latch can have: a full-latch engagement section that the first locking section of the first pole abuts in the door closed state; and a disengagement projection that causes the pivot of the second pole during a door closing operation. Moreover, the second pole can have a disengagement lever. In this way, during the door closing operation, the disengagement projection pushes the disengagement lever by the pivot of the latch to cause the pivot of the second pole, a state where the second locking section of the second pole abuts the first pole is thereby canceled, the first locking section of the first pole can retreat from the full-latch engagement section of the latch, and movement of the latch to the full-latch position is permitted.

### Advantageous Effects of Invention

Since it is possible to reduce the frictional force that is caused by the force from the latch and exerted on the second pole, which is operated by the door operation piece, an operation force of the door operation piece can be reduced.

### BRIEF DESCRIPTION OF DRAWINGS

Embodiment(s) of the present disclosure will be described by reference to the following figures, wherein:

FIG. 1 is a front view of a configuration of a working mechanism of a door lock device in this embodiment;

FIG. 2 is a perspective view of the configuration of the working mechanism of the door lock device in this embodiment;

FIG. 3 is an explanatory view of an operation of the door lock device in this embodiment and is also a view of a state when a door is opened;

FIG. 4 is an explanatory view of the operation of the door lock device in this embodiment and is also a view of a state when the door is half-opened;

FIG. 5 is an explanatory view of the operation of the door lock device in this embodiment;

FIG. 6 is an explanatory view of the operation of the door lock device in this embodiment;

FIG. 7 is an explanatory view of the operation of the door lock device in this embodiment and is also a view of a state when the door is closed;

FIG. 8 is an explanatory view of the operation of the door lock device in this embodiment;

FIG. 9 is an explanatory view of the operation of the door lock device in this embodiment; and

FIG. 10 is an explanatory view of a force that is exerted when the door is opened from a door closed state.

### DESCRIPTION OF EMBODIMENTS

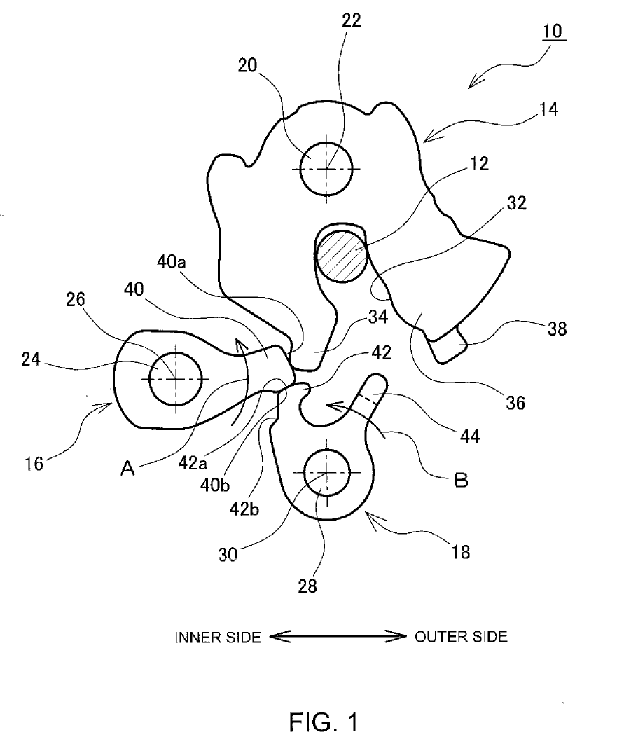

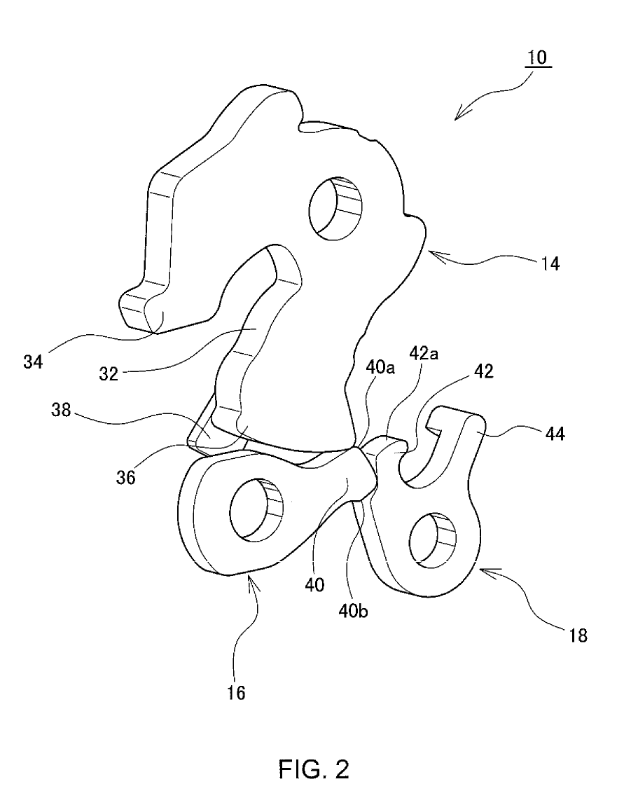

A description will hereinafter be made on an embodiment of the present disclosure in accordance with the drawings. FIG. 1 and FIG. 2 are views of a configuration of a working mechanism of a door lock device 10. In FIG. 1, a right side corresponds to an outer side of a vehicle, and a left side corresponds to an inner side; that is, a cabin side of the vehicle. The door lock device 10 is disposed at an end edge of a door of the vehicle such as an automobile. The door lock device 10 holds the door to prevent unintentional opening thereof when being engaged with a striker 12 that is fixed to a vehicle body. The striker 12 is formed by bending a metal rod stock in a U-shape, for example, and one side of the U-shaped striker 12 is involved in the engagement with the door lock device 10.

The door lock device 10 has: a latch 14 that is engaged with the striker 12; and two poles 16, 18, each of which restricts movement of the latch 14. The pole that is directly engaged with the latch 14 will be described as a first pole 16. A second pole 18 serving as the other pole is engaged with the first pole 16 and indirectly restricts the movement of the latch 14. Each of the latch 14, the first pole 16, and the second pole 18 is manufactured of a metal plate such as a steel plate. The latch 14 is supported by a latch axle 20 and is pivotable about a latch axis 22 as a center axis of the latch axle 20. The first pole 16 is supported by a first pole axle 24 and is pivotable about a first pole axis 26 as a center axis of the first pole axle 24. The second pole 18 is fixed to a second pole shaft 28 and is pivotable with the second pole shaft 28 about a second pole axis 30 as a center axis of the second pole shaft 28. In this door lock device 10, the latch axis 22, the first pole axis 26, and the second pole axis 30 are arranged in parallel.

The second pole shaft 28 pivots in accordance with an operation of a door operation piece (not illustrated). In this way, the second pole 18 pivots. The door operation piece is a rod-shaped door handle or a plate-shaped door flap that is provided on a vehicle outer surface of the door, and is also a door lever that is disposed on a vehicle inner surface (that is, the cabin side) of the door, for example. When getting in the vehicle, an occupant grasps and pulls the door handle. By this operation, the door handle moves with respect to the door, and this movement causes a pivot of the second pole 18 to a disengaged position via the second pole shaft 28. When getting out of the vehicle, the occupant pulls the door lever on the inner side of the door, and this operation causes the pivot of the second pole 18 to the disengaged position via the second pole shaft 28.

The latch 14 is formed with a receiving groove 32 that receives the striker 12, and a full-latch engagement section 34 and a half-latch engagement section 36 are provided on respective sides of the receiving groove 32. In FIG. 1, the full-latch engagement section 34 is provided on a left side of the receiving groove 32. The full-latch engagement section 34 is a portion that the first pole 16 abuts when the door is completely closed. By the abutment of the first pole 16, a clockwise pivot of the latch 14 in FIG. 1 is inhibited. When the pivot of the latch 14 is inhibited, the latch 14 holds the striker 12 in the receiving groove 32 and holds the door in a completely closed state. In FIG. 1, the half-latch engagement section 36 is provided on a right side of the receiving groove 32. The half-latch engagement section 36 is a portion that the first pole 16 abuts when the door is neither opened nor completely closed; that is, when the door is “half-shut.” By the abutment of the first pole 16, the clockwise pivot of the latch 14 in FIG. 1 is inhibited. When the pivot of the latch 14 is inhibited, the latch 14 holds the striker 12 in the receiving groove 32 and keeps the door in the half-shut state.

The latch 14 further has a disengagement projection 38. As clearly illustrated in FIG. 2, the disengagement projection 38 is disposed adjacent to a back side of the half-latch engagement section 36 in FIG. 2. The disengagement projection 38 is operated in relation to the second pole 18, and the operation of the disengagement projection 38 will be described below with the operation of the second pole 18.

In the following description, the state where the door is completely closed will be described as a “door closed state,” and the position of the latch 14 at this time will be described as a “full-latch position.” In addition, the state where the door is neither opened nor completely closed (half-shut) will be described as a “door half-shut state,” and the position of the latch 14 at this time will be described as a “half-latch position.” The state where the door is opened will be described as a “door opened state,” and the position of the latch 14 at this time will be described as a “release position.”

The first pole 16 has a first locking section 40 that is engaged with the full-latch engagement section 34 or the half-latch engagement section 36 of the latch 14. A top face 40a of the first locking section 40 contacts the full-latch engagement section 34 or the half-latch engagement section 36. The first locking section 40 is engaged with the full-latch engagement section 34 of the latch 14 in the full-latch position and thereby locks the latch 14 in the full-latch position. In addition, the first locking section 40 is engaged with the half-latch engagement section 36 of the latch 14 in the half-latch position and thereby locks the latch 14 in the half-latch position. The position of the first pole 16 at the time of being engaged with the full-latch engagement section 34 is the same as the position of the first pole 16 at the time of being engaged with the half-latch engagement section 36. Such a position will be described as a “locking position.” Meanwhile, the position of the first pole 16 at the time when the engagement thereof with the latch 14 is canceled will be described as a “retreating position.” In FIG. 1, the first pole 16 is urged counterclockwise (in a direction indicated by an arrow A). Accordingly, the first pole 16 in the retreating position is urged toward the locking position. Note that a counterclockwise pivot of the first pole 16 beyond the locking position is inhibited by a stopper, which is not illustrated.

The second pole 18 has a second locking section 42 that is engaged with the first locking section 40 of the first pole 16. A top face 42a of the second locking section 42 contacts a side face 40b of the first locking section 40. The second locking section 42 is engaged with the first pole 16 in the locking position and thereby locks the first pole 16 in the locking position. The position of the second pole 18 at the time of being engaged with the first pole 16 will be described as a “locking position,” and the position thereof at the time when the engagement with the first pole 16 is canceled will be described as a “disengaged position.” In FIG. 1, the second pole 18 is urged counterclockwise (in a direction indicated by an arrow B). Note that a counterclockwise pivot of the second pole 18 beyond the locking position is inhibited by a stopper, which is not illustrated.

The second pole 18 further has a disengagement lever 44. The disengagement lever 44 has a portion that extends toward a back side of the sheet of FIG. 1 so as to be able to contact the disengagement projection 38 of the latch 14 (see FIG. 2). In a process of moving along with the counterclockwise pivot of the latch 14, the disengagement projection 38 contacts the disengagement lever 44 and causes the disengagement lever 44 to pivot clockwise. In this way, the second pole 18 pivots clockwise and moves from the locking position to the disengaged position.

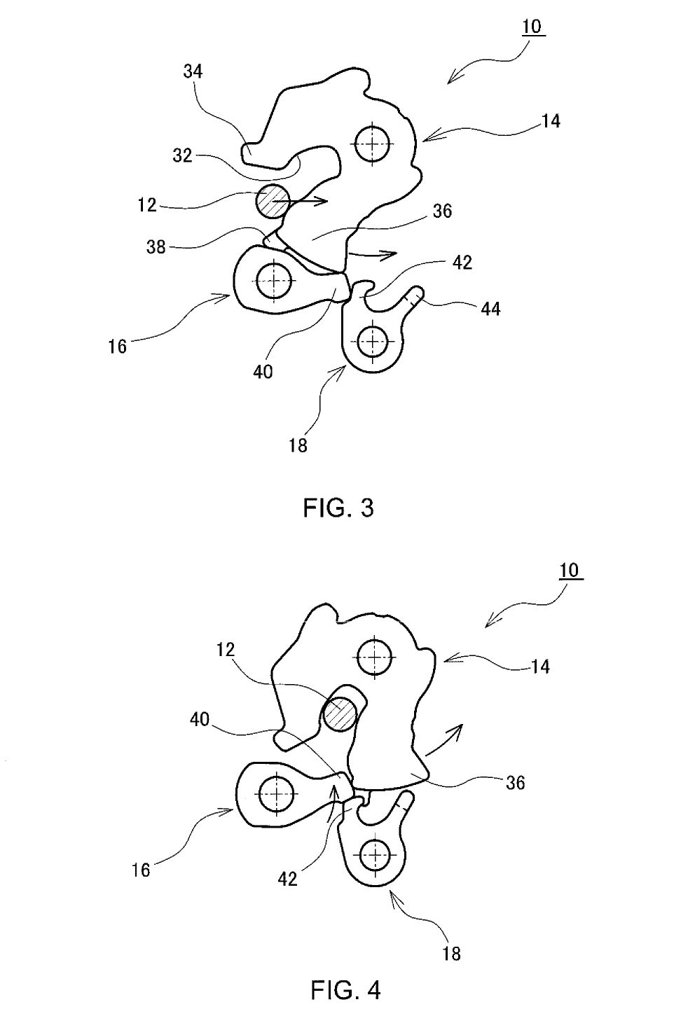

FIGS. 3 to 9 are explanatory views of the operation of the door lock device 10. First, the operation at the time of closing the door (a door closing operation) will be described.

FIG. 3 illustrates the positions of the latch 14, the first pole 16, and the second pole 18 in the door opened state. The latch 14 is in the release position that is a position where the half-latch engagement section 36 pivots clockwise beyond the first locking section 40 of the first pole 16. The release position is a position where the receiving groove 32 faces a lateral direction and the latch 14 can receive the striker 12. The first pole 16 is pushed by the half-latch engagement section 36, pivots clockwise against an urging force, and is located in the retreating position. At this time, the first locking section 40 is supported by a shoulder section 42b (see FIG. 1) of the second pole 18. Due to the abutment of the first locking section 40 of the first pole 16 against the shoulder section 42b, the second pole 18 is inhibited from pivoting counterclockwise and thus located in disengaged position.

In a process of the door closing operation, the striker 12 relatively approaches the door lock device 10. In other words, in FIG. 3, the striker 12 moves from the left side toward the door lock device 10; in particular, the receiving groove 32 of the latch 14. When the receiving groove 32 receives the striker 12, the striker 12 pushes a side face of the receiving groove 32 and causes the counterclockwise pivot of the latch 14. When the latch 14 pivots and, as illustrated in FIG. 4, the half-latch engagement section 36 passes the first locking section 40, the first pole 16 is no longer inhibited from pivoting counterclockwise by the urging force and pivots to the locking position. In conjunction with this, the second pole 18 is also no longer inhibited from pivoting counterclockwise by an urging force and pivots to the locking position. Then, the top face 42a of the second locking section 42 of the second pole 18 abuts the side face 40b of the first locking section 40 of the first pole 16, and the second pole 18 holds the first pole 16 in the locking position and brings the first pole 16 in a locked state.

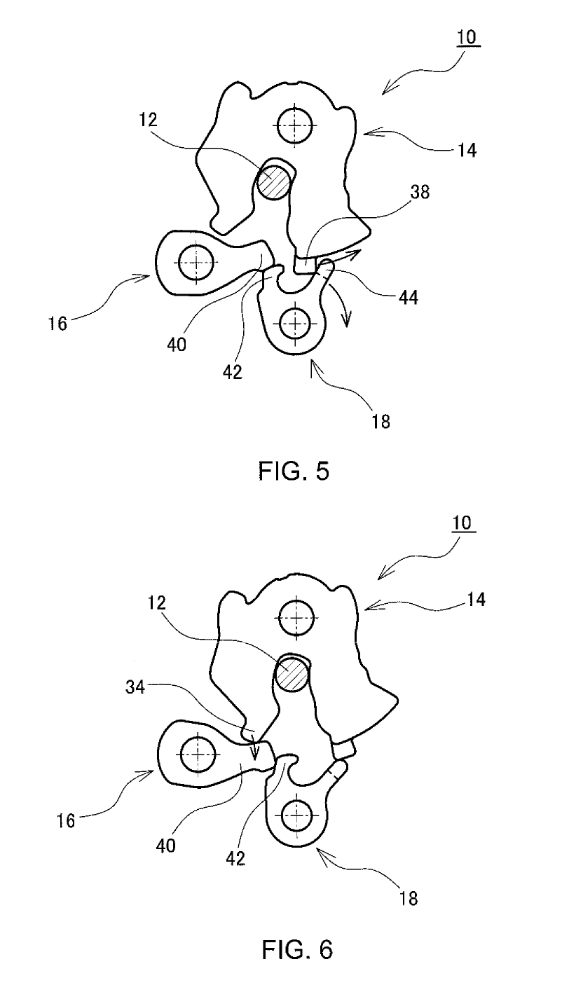

When the latch 14 is pushed by the striker 12 and further pivots, as illustrated in FIG. 5, the disengagement projection 38 of the latch 14 contacts the disengagement lever 44 of the second pole 18 and causes the disengagement lever 44 of the second pole 18 to pivot clockwise. In conjunction with this, the second pole 18 also pivots clockwise, and, as illustrated in FIG. 6, the locked state of the first pole 16 by the second pole 18 is canceled. Meanwhile, the full-latch engagement section 34 of the latch 14 pushes the first locking section 40 of the first pole 16 downward, and the first pole 16 moves to the retreating position again.

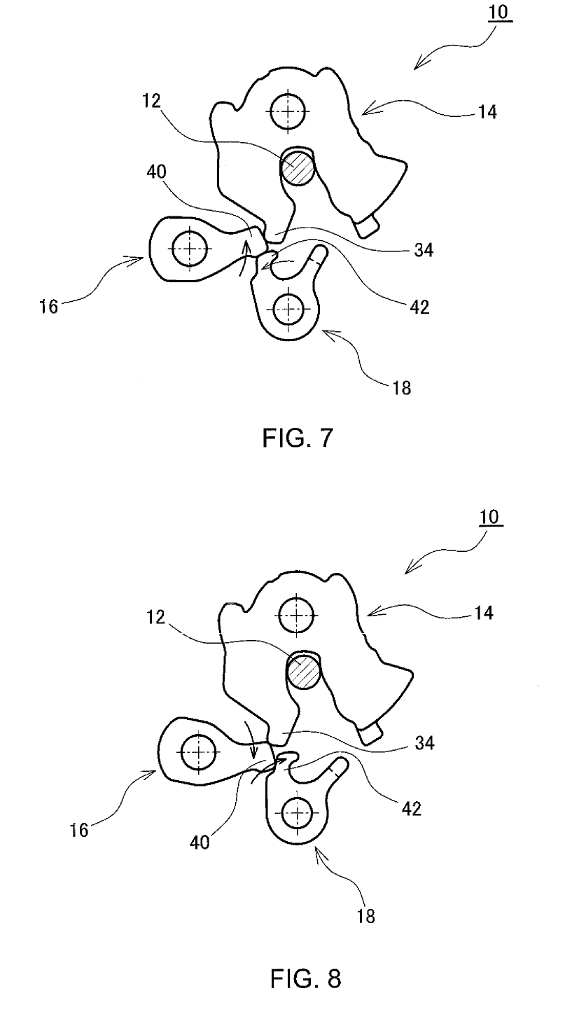

When the full-latch engagement section 34 passes the first locking section 40, as illustrated in FIG. 7, the first pole 16 returns to the locking position by the urging force, and the first locking section 40 abuts the full-latch engagement section 34. This position of the latch 14 is the full-latch position, and the latch 14 is locked and fixed in this position by the first pole 16. Even when the door is pushed in an opened direction in this state, the fixed latch 14 holds the striker 12. Thus, the door does not move.

In the case where a force of closing the door is insufficient and the latch 14 does not reach the full-latch position illustrated in FIG. 7, the movement of the door is inhibited in the middle when it is attempted to move the door in the opened direction. When the door is operated for opening in the state of the door lock device 10 illustrated in FIG. 6, the latch 14 pivots clockwise, and the first pole 16 pivots to the locking position illustrated in FIG. 5. When the latch 14 further pivots, the half-latch engagement section 36 abuts the first pole 16 in the locking position, and the first pole 16 locks the latch 14. In this way, the further pivot of the latch 14 is inhibited, and the door is not opened any further. This position of the latch 14 is the half-latch position and corresponds to a so-called half-shut state.

Next, the operation of opening the door (a door opening operation) will be described. In the door closed state illustrated in FIG. 7, when getting in the vehicle, the occupant grasps the door operation piece; for example, the door handle, to open the door. At this time, the door moves in the opened direction. By this movement, the latch 14 receives a force of causing the clockwise pivot thereof from the striker 12, and this force is further exerted on the first locking section 40 of the first pole 16. Meanwhile, when the door handle is pulled, the second pole 18 pivots clockwise to the disengaged position. When the second pole 18 moves to the disengaged position as illustrated in FIG. 8, the first pole 16 is no longer supported by the second pole 18, pivots clockwise by a force received from the full-latch engagement section 34 of the latch 14, and moves to the retreating position. In this way, the latch 14 is unlocked, and the counterclockwise pivot of the latch 14 is permitted.

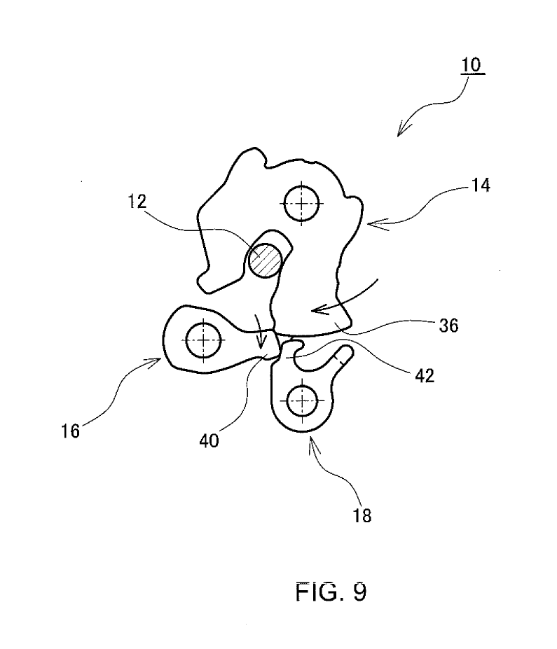

When the full-latch engagement section 34 separates from the first pole 16, the first pole 16 returns to the locking position by the urging force. Thereafter, when the latch 14 further pivots and the half-latch engagement section 36 abuts the first locking section 40, the first locking section 40 receives a force from the half-latch engagement section 36. Because the door handle is pulled at this time, the second pole 18 is in the disengaged position, and the first pole 16 is unlocked. Accordingly, as illustrated in FIG. 9, the first pole 16 pivots clockwise by the force received from the half-latch engagement section 36 and moves to the retreating position. In this way, the latch 14 is permitted for the further pivot and pivots to the release position illustrated in FIG. 3. At the release position, the receiving groove 32 is opened, and the striker 12 is released.

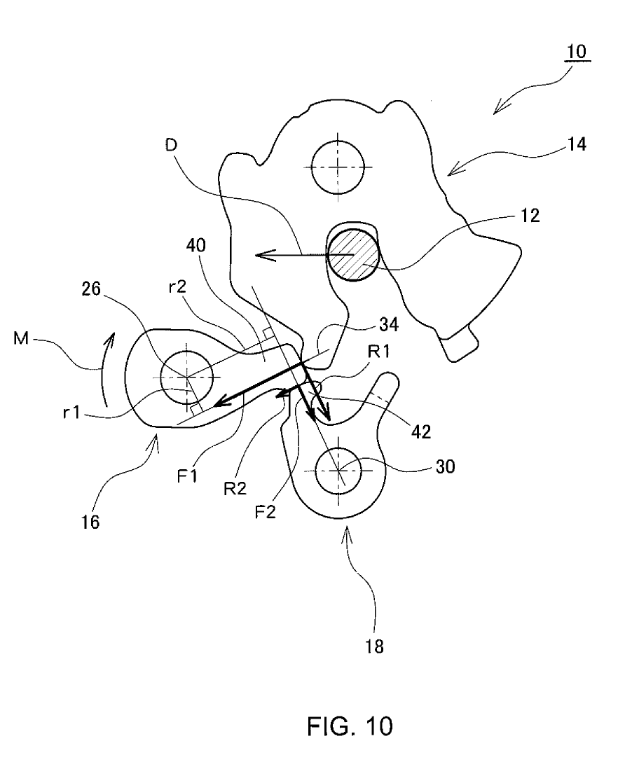

FIG. 10 is an explanatory view of a force that is exerted when the door is opened from the door closed state. In the door closed state, the latch 14 is in the full-latch position, and each of the first pole 16 and the second pole 18 is in the locking position. When the door is opened from the outside, the door handle is grasped and pulled. In this way, the door handle moves with respect to the door, and the door moves in the opened direction. Thus, the latch 14 and the second pole 18 pivot almost simultaneously. When the door is opened from the inside, the door is pushed from the inside while the door lever is operated. Also, in this case, the latch 14 and the second pole 18 pivot almost simultaneously.

When the door moves in the opened direction, the striker 12 attempts to move in a direction indicated by an arrow D in FIG. 10. The latch 14 receives the force from the striker 12 and attempts to pivot clockwise. By this movement, a force F1 that is exerted on the first locking section 40 of the first pole 16 from the full-latch engagement section 34 of the latch 14 is generated. This force F1 generates moment M around the first pole axis 26. A magnitude of this moment M will be expressed as below when length of the moment arm around the first pole axis 26 is set as r1.

M=F1×r1 (1)

This moment M generates a force F2 that is exerted on the second locking section 42 of the second pole 18 from the first locking section 40 of the first pole 16. A magnitude of the force F2 will be expressed as below when length of the moment arm around the first pole axis 26 is set as r2.

F2=M/r2 (2)

In this door lock device 10, a dimension of each portion of each of the components such as the first pole 16 and the second pole 18 is determined such that the force F2 crosses the second pole axis 30. Since the force F2 crosses the second pole axis 30, the force F2 does not generate moment around the second pole axis 30. Accordingly, in the door closed state, even when the occupant attempts to open the door without operating the door operation piece, for example, simply by pushing the door from the cabin side, a force of causing the pivot of the second pole 18 does not act, and the first pole 16 is kept in the locked state. In addition, the latch 14 is kept in the locked state by the first pole 16, and opening of the door is thereby prevented.

Furthermore, in this door lock device 10, the dimensions of the portions of the respective components such as the first pole 16 and the second pole 18 are determined such that the length r1 of the moment arm related to the force F1 becomes shorter than the length r2 of the moment arm related to the force F2.

r1<r2 (3)

From the equations (1) to (3), the following equation is obtained.

F1>F2 (4)

That is, in this door lock device 10, the force F2 that is exerted on the second pole 18 from the first pole 16 is smaller than the force F1 that is exerted on the first pole 16 from the latch 14.

In addition, it is considered that a friction coefficient at a contact point between the full-latch engagement section 34 of the latch 14 and the first locking section 40 of the first pole 16 is almost equal to a friction coefficient at a contact point between the first locking section 40 of the first pole 16 and the second locking section 42 of the second pole 18 in the case where the latch 14, the first pole 16, and the second pole 18 are manufactured of the same material and by a general method. When the friction coefficient is set as μ, the following relationship is established between a frictional force R1 (=μ×F1) between the full-latch engagement section 34 and the first locking section 40 and a frictional force R2 (=μ×F2) between the first locking section 40 and the second locking section 42 from the equation (4).

R1>R2 (5)

Accordingly, the frictional force that resists the pivot of the first pole 16 or the second pole 18 is smaller at the time when the second pole 18 pivots than the time when the first pole 16 pivots by the operation of the door operation piece. Thus, an operation force of the door operation piece is reduced. As a result, an operation force of the door handle or the door lever at the time of opening the door can be reduced.

### REFERENCE SIGNS LIST

10: Door lock device
12: Striker
14: Latch
16: First pole
18: Second pole
20: Latch axle
22: Latch axis (first axis)
24: First pole axle
26: First pole axis (second axis)
28: Second pole shaft
30: Second pole axis (third axis)
32: Receiving groove
34: Full-latch engagement section
36: Half-latch engagement section
38: Disengagement projection
40: First locking section
42: Second locking section
44: Disengagement lever

1. A door lock device provided in a door of a vehicle, the door lock device comprising:
a latch that has a receiving groove and is pivotable about a first axis, the receiving groove receiving a striker that is fixed to a vehicle body;
a first pole that has a first locking section and is pivotable about a second axis, the first locking section abutting the latch and keeping the latch in a full-latch position in a door closed state; and
a second pole that has a second locking section and pivots about a third axis to a disengaged position by an operation of a door operation piece during a door opening operation, the second locking section abutting the first pole and keeping the first pole in an abutting state against the latch in the door closed state, wherein
in the door closed state, an arm of moment that is generated around the second axis by a force exerted on the first locking section of the first pole from the latch is shorter than an arm of moment around the second axis that generates a force exerted on the second locking section of the second pole from the first pole.

2. The door lock device for the vehicle according to claim 1, wherein
the latch has: a full-latch engagement section that the first locking section of the first pole abuts in the door closed state; and a disengagement projection that causes a pivot of the second pole during a door closing operation,
the second pole has a disengagement lever, and
during the door closing operation, the disengagement projection pushes the disengagement lever by the pivot of the latch to cause the pivot of the second pole, a state where the second locking section of the second pole abuts the first pole is thereby canceled, the first locking section of the first pole can retreat from the full-latch engagement section of the latch, and movement of the latch to the full-latch position is permitted.
